(19) United States
(12) Patent Application Publication
(10) Pub. No.: US 2020/0224692 A1
(43) Pub. Date: Jul. 16, 2020

(54) RODENT BARRIER COMPONENTS

(71) Applicants: Chih-Yu Hsia, Arcadia, CA (US); Michael Jonathan Hsia, Pasadena, CA (US); Patricia Shirley Hsia, Pasadena, CA (US)

(72) Inventors: Chih-Yu Hsia, Arcadia, CA (US); Michael Jonathan Hsia, Pasadena, CA (US); Patricia Shirley Hsia, Pasadena, CA (US)

(21) Appl. No.: 16/244,774

(22) Filed: Jan. 10, 2019

(51) Int. Cl. F16B 7/04; A01G 13/10; A01M 29/30; F16L 21/00

(52) U.S. Cl. CPC F16B 7/0486; F16L 21/002; A01M 29/30; A01G 13/10

(57) ABSTRACT

A component many of which to be joined together to form a rodent barrier consists of a protruding rod and two protruding rods and two holes for linking the component with other components which have the same or similar dimensions and constructions of the component to be joined; the protruding rod is generally perpendicular to the two protruding rods and the two holes for linking the component with other components; two variations of the components presented.

### CROSS-REFERENCE TO RELATED APPLICATIONS

Not Applicable.

### BACKGROUND OF THE INVENTION

This invention relates to means to prevent rodents from traveling along a tree branch or a rod to unwelcome areas.

### BRIEF SUMMARY OF THE INVENTION

Rodents stealing fruits from trees have been an issue for fruit growers. Normally rodents approach fruits by climbing along tree branches. If the pathways on the tree branches can be stopped, then the snapping fruits off a fruit tree by rodents can be stopped. Additionally, rodents may climb poles and posts to travel from location to location. Reduction in this travel will result in reduction of spread of unwanted vermin. Therefore, means to stop the pathways have been sought.

The current invention provides components for a device which can be strategically affixed on a tree branch, trunk, or other type of rod or post. This device will create a fence-like barrier which fans outwards from the surface of the tree branch, trunk, or rod or post. The fence-like barrier will prevent rodents from travelling around it. The fence-like barrier will be flexible and slippery enough to not allow rodents to climb over it. The lengths of the invented device can be easily altered for mounting on objects of different diameters.

These, and other objects and advantages of the invention, as well as the details of illustrative embodiments, will be more fully understood from the following specification and drawings, in which:

### BRIEF DESCRIPTIONS OF THE SEVERAL VIEWS OF THE DRAWINGS

FIG. 1 is an isometric view of a single unit of the invented component. Hidden lines are not shown.

FIG. 2 is an isometric view of the same single unit of the invented component shown in FIG. 1. Hidden lines are shown.

FIG. 3 is an isometric view of a variation of the invented component. Hidden lines are not shown.

FIG. 4 is an isometric view of the same variation of the invented component shown in FIG. 3. Hidden lines are shown.

FIG. 5 is an isometric view which illustrates the uses of the invented components which is shown in FIG. 1 and FIG. 2.

FIG. 6 is an isometric view which illustrates the uses of the invented components which is shown in FIG. 3 and FIG. 4.

### DETAILED DESCRIPTION OF THE INVENTION

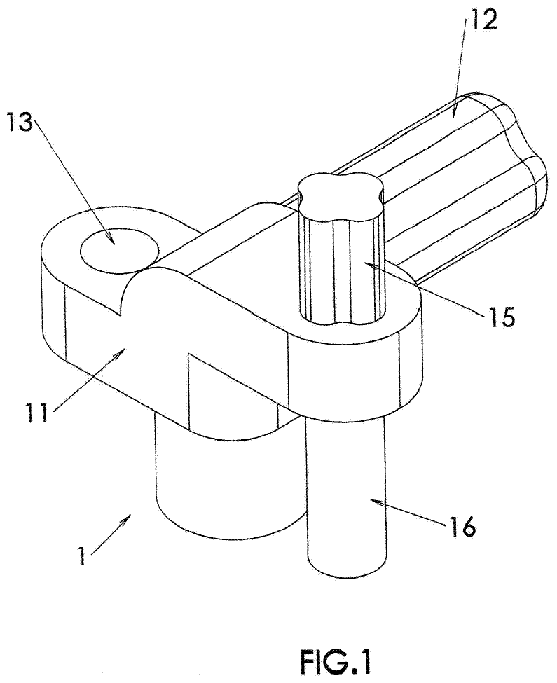

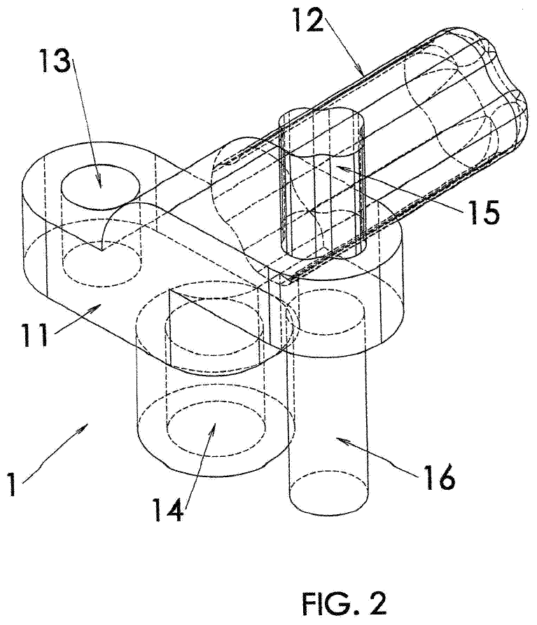

Referring to FIG. 1 and FIG. 2, the invented component for a rodent barrier 1 consists of a body 11, a protruding rod 12 for mounting a tube like object, such as a straw, a penetrating hole 13, a hole 14, a protruding rod 15 which can engage with the hole 14, and another protruding rod 16 which can engage with the penetrating hole 13. The penetrating hole 13 and the protruding rod 16 are on the opposite ends of the body 11. The hole 14 and the protruding rod 15 and on the opposite side of the body 11. The protruding rod 15 and the protruding rod 16 are on the opposite side of the body 11. The protruding rod 12 is generally perpendicular to the axis of the penetrating hole 13, the hole 14, the protruding rod 15 and the protruding rod 16.

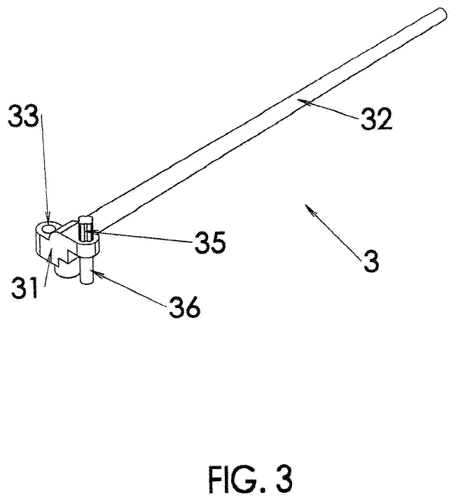

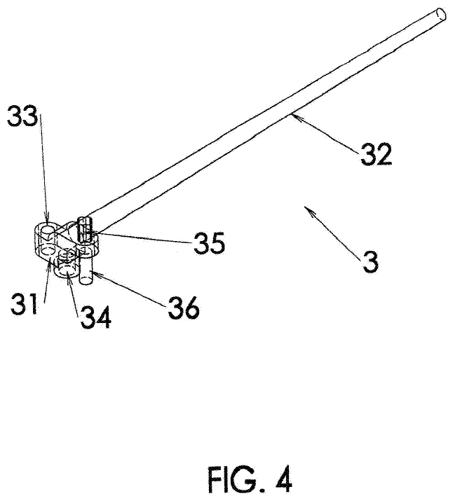

Referring to FIG. 3 and FIG. 4, a variation of the invented component for a rodent barrier 3 consists of a body 31, a protruding rod 32, a penetrating hole 33, a hole 34, a protruding rod 35 which can engage with the hole 34, and another protruding rod 36 which can engage with the penetrating hole 33. The penetrating hole 33 and the protruding rod 36 are on the opposite ends of the body 31. The hole 34 and the protruding rod 35 and on the opposite side of the body 31. The protruding rod 35 and the protruding rod 36 are on the opposite side of the body 31. The protruding rod 32 is generally perpendicular to the axis of the penetrating hole 33, the hole 34, the protruding rod 35 and the protruding rod 36.

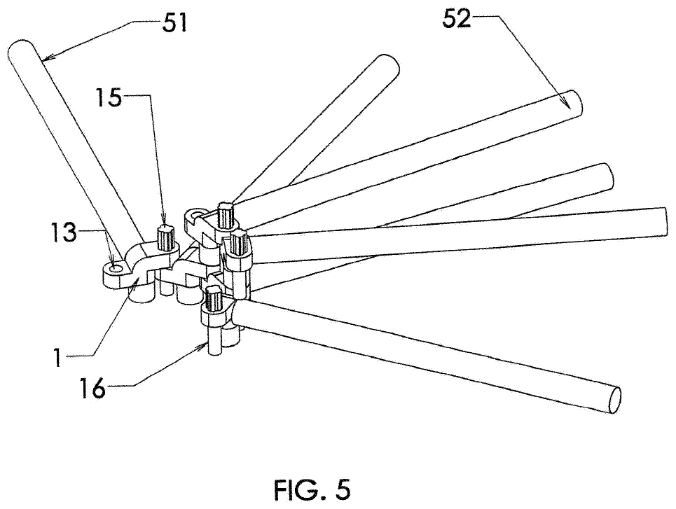

Two or more of the invented components can be joined together to form a rodent barrier or its basis. Referring to FIG. 5, many invented components can be joined together to form a chain which can encircle around a branch of a tree (the encirclement and the tree branch are not shown for drawing clearness purpose). Two invented devices are joined together by putting the protruding rod 16 of one invented device 1 through the penetrating hole 13 of another invented device 1. A tube 51, such as a straw, is put on the protruding rod 12. The tube 51 will fan out on the tree branch to create a barrier for a travelling rodent. The smaller the diameter of the tree is, the shorter the chain of the joined invented components becomes and the larger the angle between two adjacent tube 51 becomes. When the diameter of the tree branch is too small, the spacing between two adjacent tubes 51 becomes too large to prevent a rodent from trespassing. Then, a second layer of the barrier is needed. To form a second layer of the barrier, the hole 14 (referring to FIG. 2) of the second chain of the invented components is placed to engage with the protruding rod 15 of the first chain of the invented components. The tubes 52 (referring to FIG. 5) of the second layer of the barrier will divide the angle between the tubes 51 of the first layer. The gaps between two tubes are therefore reduced. The stiffness of the body will keep the barrier rods fan outwards of the branch. Due to the sizes of the invented components, the gaps between the tubes will be sufficiently small that the rodents cannot squeeze through the tubes. The flexibility and the smoothness of the barrier rods will not provide any holding point for the rodents to hang onto. Therefore, the rodents cannot climb over the barrier. These invented rat/squirrel barriers can keep rats/squirrels from access to unwanted areas.

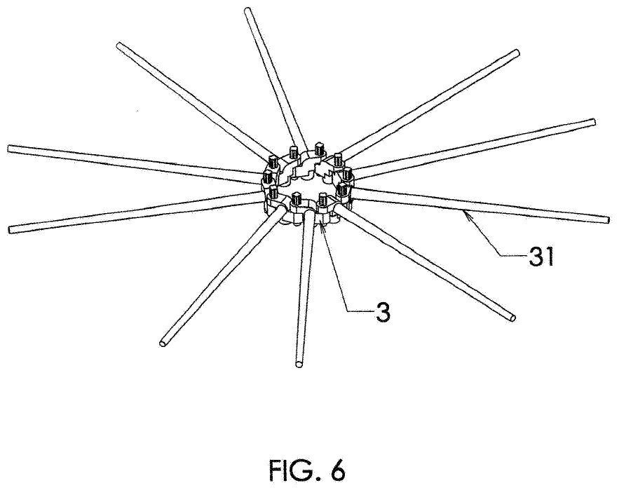

In lieu of using the tubes 51 (FIG. 5), the invented components can have the elongated protruding rod 32 (FIGS. 3, 4 and 6) instead. Joining and using of the invented components shown in FIG. 3 will be similar to those described for the components shown in FIGS. 1, 2 and 5.

The foregoing is considered as illustrative only of the principles of the invention. Furthermore, since numerous modifications and changes will readily occur to those skilled in the art, it is not desired to limit the invention to the exact construction and operation shown and described, and accordingly all suitable modifications and equivalents, may be resorted to, falling within the scope of the invention as claimed.

We claim:

1. A component of a rodent barrier that has a protruding rod for mounting a tube and two protruding rods and two holes for linking said component with other components which have the same or similar dimensions and constructions of said component; said protruding rod for mounting a tube being generally perpendicular to axis of said two protruding rods and said two holes for linking said component with other components.

2. A component of a rodent barrier that has a protruding rod and two protruding rods and two holes for linking said component with other components which have the same or similar dimensions and constructions of said component; said protruding rod being generally perpendicular to axis of said two protruding rods and said two holes for linking said component with other components.
